(19) United States
(12) Patent Application Publication
(10) Pub. No.: US 2008/0155114 A1
(43) Pub. Date: Jun. 26, 2008

(54) Digital distribution system for dynamic media

(75) Inventors: Thomas Edward Mungavan, Plymouth, MN (US); Loren J. Lovhaug, Shoreview, MN (US)

Correspondence Address: MOORE & HANSEN, PLLP, 225 SOUTH SIXTH ST, MINNEAPOLIS, MN, 55402, US

(73) Assignee: Change Masters, Incorporated

(21) Appl. No.: 11/999,673

(22) Filed: Dec. 5, 2007

Related U.S. Application Data
(63) Continuation of application No. 10/036,642, filed on Dec. 31, 2001, now abandoned.

(51) Int. Cl. G06F 15/16

(52) U.S. Cl. 709/231

(57) ABSTRACT

A system for distributing dynamically constructed customized media content via a network. Content is assembled to create a customized product for a database-managed subscriber list both on-demand or at pre-defined intervals based upon collected information or a pre-defined content program. Content of future transmissions or their scheduling may be adjusted by the system based upon user-feedback provided interactively and on-line. Content is assembled by remotely callable daemon applications that can work in parallel to increase throughput and distribution from different locations. These applications may be deployed across multiple servers distributed over a local or wide area network, and enable the server to transmit content on a regular schedule and to manage multiple conduits for media distribution. The system can schedule and reschedule a single or a series of deliveries over a period of time, and also includes the ability to reschedule, resend, or recreate content, reassembling it as needed.

This application claims the benefit of prior filed, co-pending non-provisional application Ser. No. 10/036,624, filed Dec. 31, 2001, by Thomas Mungavan et al, and incorporated herein by reference.

### FIELD OF THE INVENTION

The present invention relates to the networked transmission of media. More specifically, the present invention relates to interactive and non-interactive media that is dynamically assembled and delivered to a user in a customized manner that is based on heuristically achieved goals and feedback from a variety of sources.

### BACKGROUND OF THE INVENTION

From rather modest beginnings, the Internet has evolved from a simple communication tool used by a few people in academia to a sophisticated entity with multiple applications and uses. The reasons for the popularity of the Internet are many, with, convenience, speed of operation, graphical-user-interfaces, and cost being major factors. The Internet is now so pervasive that is often forms a part of many business infrastructures, and having a web presence or access to the Internet is the rule, rather than the exception. Electronic mail, though, is still at the heart of the Internet and it too has become more sophisticated. With the creation of a variety of advanced compression techniques for media, new avenues for the distribution of content to end-users have opened. Today, the Internet is used to distribute media in the form of audio and video files that are both pre-defined and “streamed” which allows content to be viewed in a near real-time fashion. In addition to offering streaming content, various audio and video compression techniques give a user the ability to record and store content such that it may be replayed on secondary devices. Portable MP3 players, portable players supporting other formats (Microsoft Windows Media, for example) and Personal Digital Assistants (PDAs) capable of listening to audio or viewing video offline have all contributed to an increase in the ability of consumers to utilize electronic media from any location at any time.

Usually, this content must be requested by an end-user. Typically, a user manually searches through a broad set of listings in order to identify a particular piece of content that is of interest. Once selected, a particular piece of content (that has already been created) is sent to the user, either as a file or in a “streaming” format. In some cases, video or audio streams are sent in sequence to allow the insertion of advertising or other content. If the content is part of a series or part of a set of related pieces of media in which the user is interested, the user is often required to repeat the process of acquiring each successive, related piece of content.

Information about an end-user is typically collected in a voluntary fashion, and often forms an important component of many content-driven web sites. Often promotional material is provided to the user based upon their demographic information. However, this material is usually in text form with minimal customization, such as the insertion of an individual's name, for example.

With the proliferation of available online content, technologies have been developed to digitize, create and author media. These technologies typically allow content providers to manually author their own customized content. Content is then encoded and provided in streaming or static file formats for user download. While the technologies developed to date have increased the ability of content providers to assemble transmission of content, the personalization of such content has not kept pace.

There is a need for a system that is able to assemble a program package that includes audio, video and text that is personalized to an individual subscriber. There is also a need for a system that is able to vary the content of the personalized packages based upon input from a variety of different sources. There is yet another need for a system that is able to combine static files with dynamic files into program packages sent to subscribers. Further, there is a need to provide personalized information at just the right moment (“just in time”) that is relevant and customized.

### SUMMARY OF THE INVENTION

The present invention, as embodied and broadly described herein, is a system and method for dynamically creating and distributing customized electronic media content based upon a pre-defined script, commands, and/or criteria about a content consumer to a plurality of destination hosts. A preferred embodiment of the invention comprises a method of creating and encoding content, and the transmission of that content across the Internet to targeted destination hosts through e-mail in a “just in time” format.

A related aspect of the invention is a method of authoring the scripted construction of content programs for “just in time” media delivery. This method comprises a series of steps comprising: defining the content elements to be transmitted including dynamic elements that may change based upon specific database driven criteria; setting the schedule for transmission; and subsequently incorporating the program into a broader product that is provided to a particular customer or set of customers.

In another embodiment, the selection of content and the scheduling of content delivery may be based on survey data and feedback data measuring the effectiveness and relevance of prior content deliveries. In this embodiment, the system works heuristically, processing survey information from subscribers and subsequently modifying the content they receive based upon this feedback.

Another aspect of the invention is a method for creation, management and distribution of product offerings that may consist of multiple, discrete, customized programs. With this method, the specific programs that make up a product offering are selected, defined and stored in a back-end database. A subsequent-delivery schedule is created for the delivery of products to customers. This method also includes the steps of entering and recording customer data, management and transmission of content, and logging success or failure in content transmission. In this method, content including custom elements, is generated immediately prior to transmission in a “just in time” fashion. The invention also includes corresponding systems for performing these processes and methods as disclosed and claimed.

An object of the present invention is to provide content that includes static and dynamic elements.

Another object of the invention is to provide individualized or customized content to subscribers.

A feature of the invention is that content may be changed on-the-fly just before transmission of the content.

Another feature of the present invention is that the content may also be changed by feedback and input from a variety of sources.

An advantage of the present invention is that the content is customized and up-to-date.

These and other objects, features and advantages of the present invention may be more completely understood by considering the following detailed description of a preferred embodiment of the invention. In the course of this description, reference will frequently be made to the attached drawings. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of the specification, illustrate several preferred embodiments of the invention and, together with the description of preferred implementations, serve to explain the principles of the invention.

FIG. 1 is a diagram illustrating a preferred embodiment of the primary system architecture and associated support applications together with their specific functions;

FIG. 2 is a schematic diagram illustrating a distribution system messaging interaction of the preferred embodiment and how content of transmissions is assembled prior to distribution;

FIG. 3 outlines the functioning of audio assembly queue as it constructs task “recipes” (or instructions) used by the assembly daemon to assemble “just in time” media content;

FIG. 4 diagrams the functions of the assembly daemon software application used to encode and deliver dynamically created media content;

FIG. 5 is a flow chart illustrating the relational hierarchy that applies to media programming distributed by the system;

FIG. 6 is a flow chart illustrating how individualized transmissions are created by merging programs to form packages that comprise a subscription;

FIG. 7 illustrates the general process flow the system uses in the preferred distribution and assembly of dynamic media content;

FIG. 8 diagrams the overall process flow associated with the creation, distribution, subscriber management and heuristic processes associated with media in the Digital Distribution System;

FIG. 9 illustrates the process used by the system to dynamically adjust the schedule and actual content sent to content subscribers based upon their on-line feedback; and,

FIG. 10 diagrams the process by which surveys are used to track progress and tailor individual content.

### DETAILED DESCRIPTION

Reference will now be made in detail to the construction and operation of preferred embodiments of the present invention, which are partially illustrated, in the accompanying drawings.

The following description of a preferred embodiment of the present invention is only exemplary of the invention. The present invention is not limited to this embodiment, but may be realized by other embodiments.

As a rule, the overall program architecture of the system is characterized by several broadly applied design principles. First, individual components of the system may be distributed widely across different pieces of hardware as each application communicates via easily distributed network messaging protocols. And secondly, multiple instances of critical components can easily be added to improve scalability.

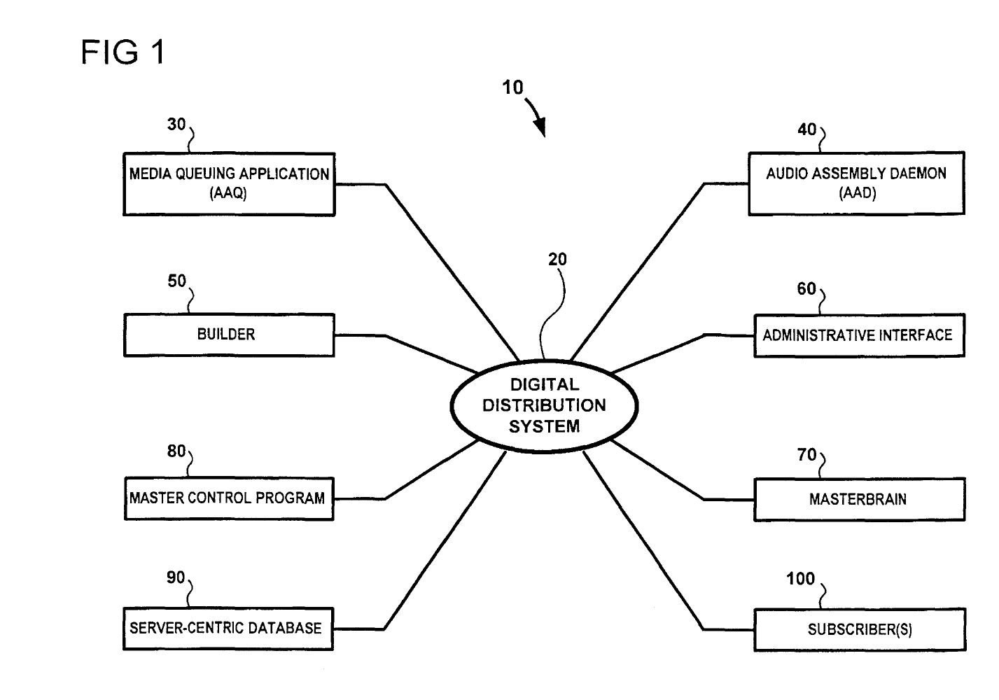

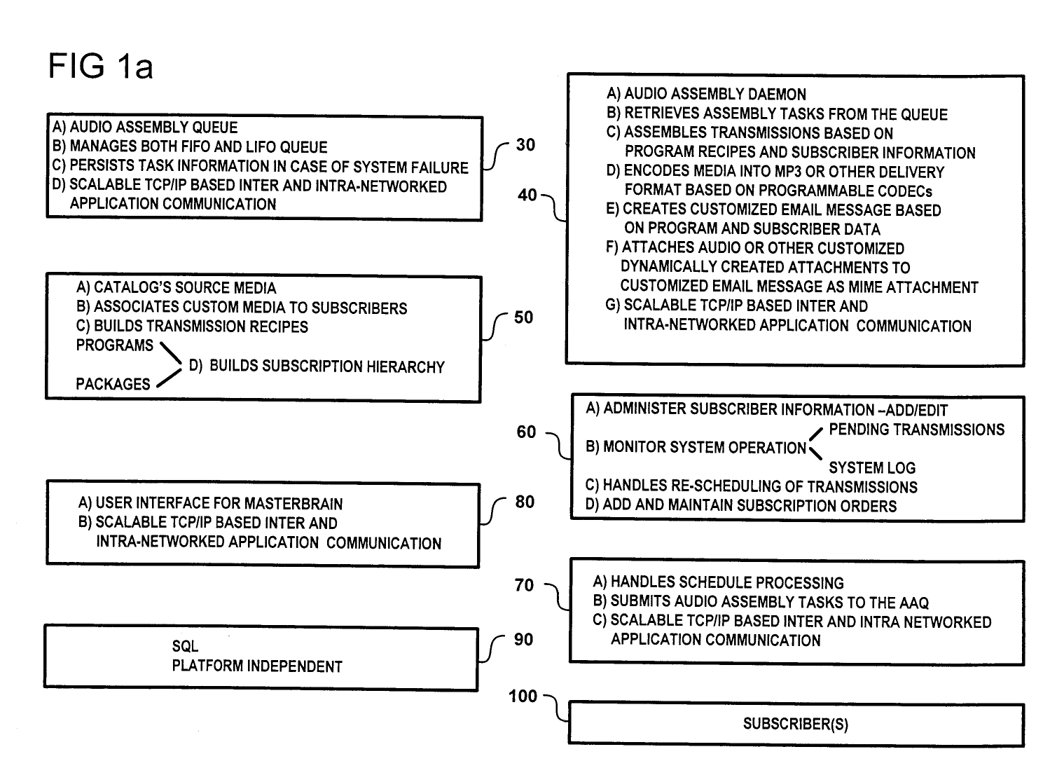

Referring now to FIG. 1, a primary system architecture 10 and associated support applications together with their specific functions is depicted. As shown in the figure the system 10 comprises of a series of related components that communicate with one another over a network through a distribution system 20 that may include a plurality of processors. The components include a variety of applications that perform different functions from different locations, with the individual system components existing as discrete, encapsulated software client and server applications that may reside independently of one another on separate hardware systems distributed across a wide or local area network.

More specifically, the system consists of multiple sets of server software applications that interact with each other in concert to produce a desired content. Starting with the upper left corner, a Media Queuing Application (AAQ) 30 is used to manage and queue audio files. As shown in the upper right corner, an Audio Assembly Daemon (MD) 40 is used to assemble audio files. The AAQ 30 sequences the assembly schedule and the MD 40 is responsible for assembly and transmission of media content.

Continuing, a Builder 50 (located below the MQ 30) is used to create “recipes” (or instruction sets) for the dynamic content products (or packages) and programs, while an Administrative Interface 60 is used to provide human administration and management, and control over system operations, logging, transmission scheduling, orders and subscriber information. The overall processes are monitored by a Masterbrain application 70 (lower right) that monitors scheduling and an associated Master Control Program 80 (lower left) that provides a human administration and management interface to the Masterbrain 70. Preferably, TCP/IP messaging is used for communication between these application components.

It will be appreciated that many AADs could be run with an associated MD distribution load between them categorized by package, program, individual, or other pre-defined criteria. It will also be appreciated that because related, individual applications are encapsulated and equipped with standard interfaces, an MD may be seamlessly replaced with a component that might instead encode video without requiring modification to the AAQ or related components. Each component functions independently and works in parallel with the others, as noted below in their detailed descriptions. In addition, the system utilizes an accessible persistent Server-Centric (or persistent) Database 90 (at bottom) to retain information related to every aspect of program definition, client and customer records and transmission logging.

While the depiction represents a preferred implementation, it should be understood that the discrete components are multipurpose and not tied to the specific file and transmission formats noted therein, and that the invention contemplates an extensible architecture that allows for additional components to be added with support for new transports and encoding technologies.

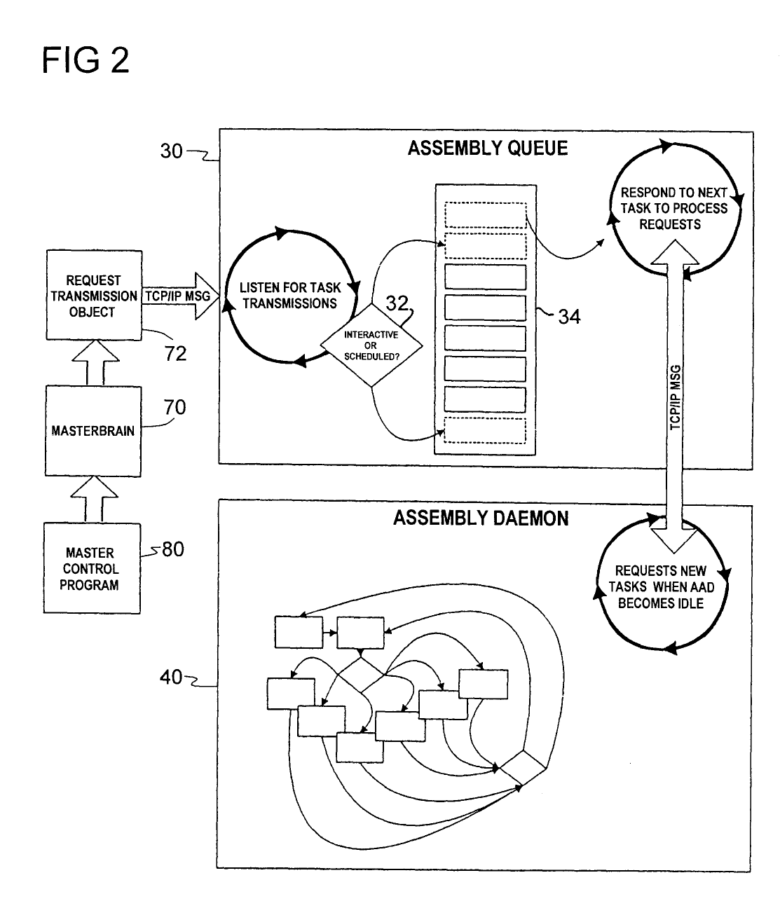

Referring now to FIG. 2, the flow of data between these program components is depicted. As can be seen, media is processed by components in a sequential manner, with each component performing a different function in the definition, assembly and scheduling of media distribution. As shown, when a subscription begins, an end user request is routed through the master control program 80. The request then proceeds to the Masterbrain 70 application, which determines scheduling information from the database and submits a request 72 through a network messaging protocol like TCP/IP. The request 72 comprises a series of assembly tasks that are received by the MQ 30.

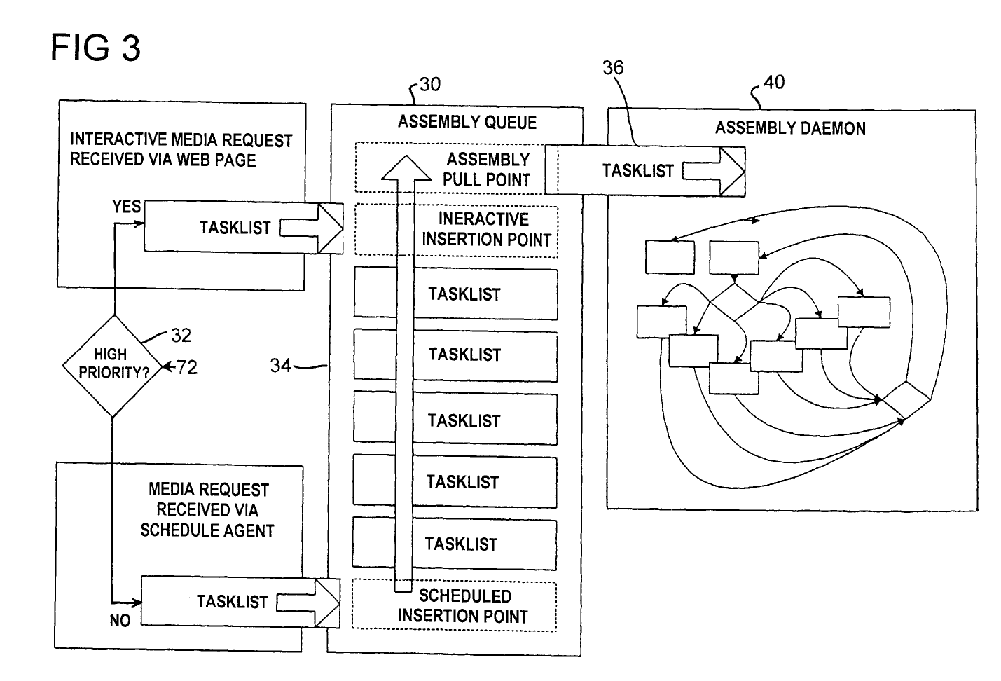

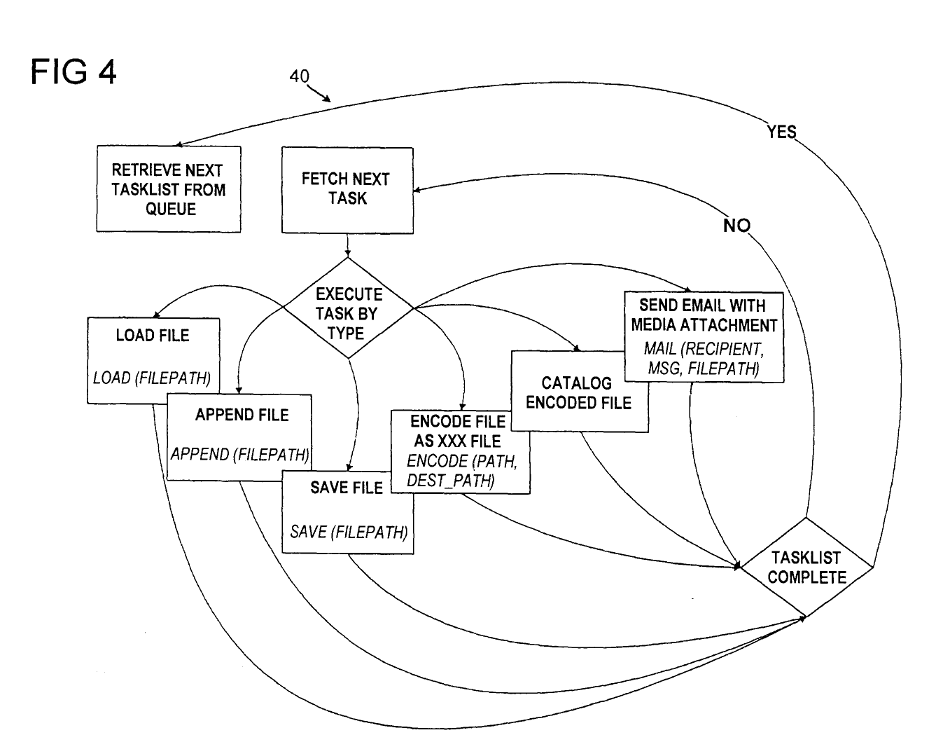

Referring to FIG. 3, the AAQ 30 is responsible for queuing requests made for scheduled or interactive content transmission 32 and it manages the insertion of individual task lists 34 that are then transmitted to the MD 40 (see also, FIG. 4). The MQ 30 also supports prioritization 32 with both first-in first-out (FIFO) and last-in first-out (LIFO) transmission schemes, for example. In addition, the MQ 30 archives (or persists) task information to the Server-Centric Database 90 in case of system failure, allowing the Masterbrain 70 to intelligently reschedule transmissions as needed (see, FIG. 1). The MQ 30 sends out transmission requests 36 to one or more daemon applications 40 and receives completion information from the MD 40, which serves to insure that the daemons are not overwhelmed with transmissions.

Referring to FIG. 4, the MD 40 provides the system with the ability to dynamically construct content based upon a list of tasks when a transmission request is made (see also, FIG. 3). The MD 40 assembles (or bundles) media files based upon the defined recipe (or instruction set), encoding them into an appropriate format and then transmitting them over a network to a given subscriber. As shown in the figure, a set of “recipe” derived task lists are used by the MD 40 to gather and assemble content for transmission to each individual subscriber. To properly identify a program file, one or more subscriber-specific elements are inserted into the clip to provide immediate source identification if a clip is improperly redistributed. The interface does not require the user to separately define programs for each subscriber. Rather, a single program definition can be used to dynamically insert user-specific content at the time of encoding. Additional dynamic content that may change on a daily basis, or moment-to-moment, like a customer specific news report, may also be defined.

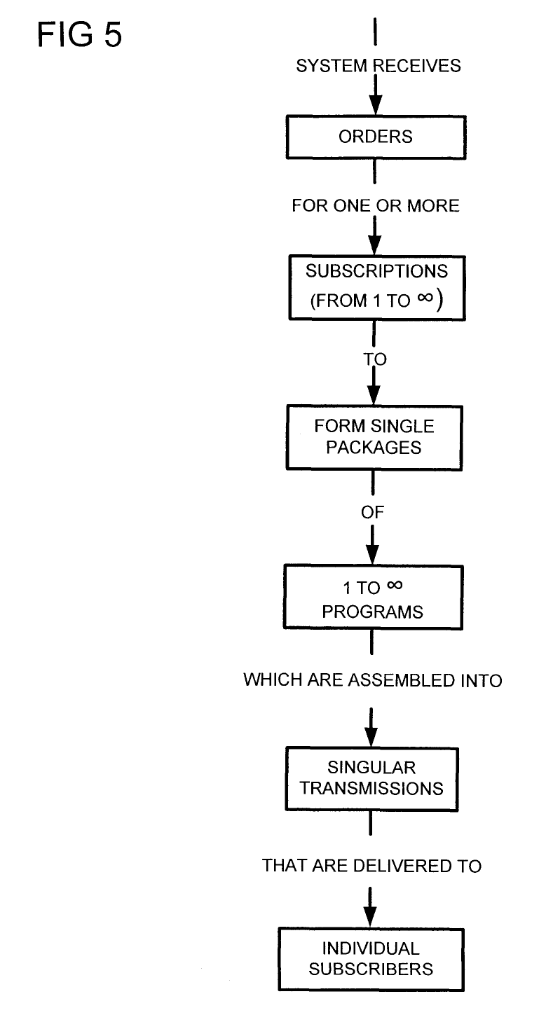

Referring now to FIG. 5, the logical model presented depicts the organization of media information provided by the system. Individual media “programs” consisting of assembled items of viewable or listenable interactive or non-interactive content are organized into a discrete subscriber specific package that is requested in a subscription order. When a new subscription is purchased programs are assigned, together with an interval-driven delivery schedule, to one or more subscribers. As this takes place, scheduling, product and package definition, subscriber information and related data is archived (or persisted) to an independent Server-Centric Database 90.

Once ordered, programs are assembled into subscriber specific packages that are sent to individual subscribers according to a timed schedule. After specifying the set of desired programs, the user subsequently uses the system to gather programs into specific packages. Packages are product offerings made up of sets of programs that may be transmitted in a sequenced order. In a preferred implementation these packages consist of audio files presented to the user in series. A user would receive individual programs over a period of days, weeks, months, or multiple years with each program related to an overall package, until the programs within that package are exhausted. Alternatively, the packages may vary the content delivery based on need or interest.

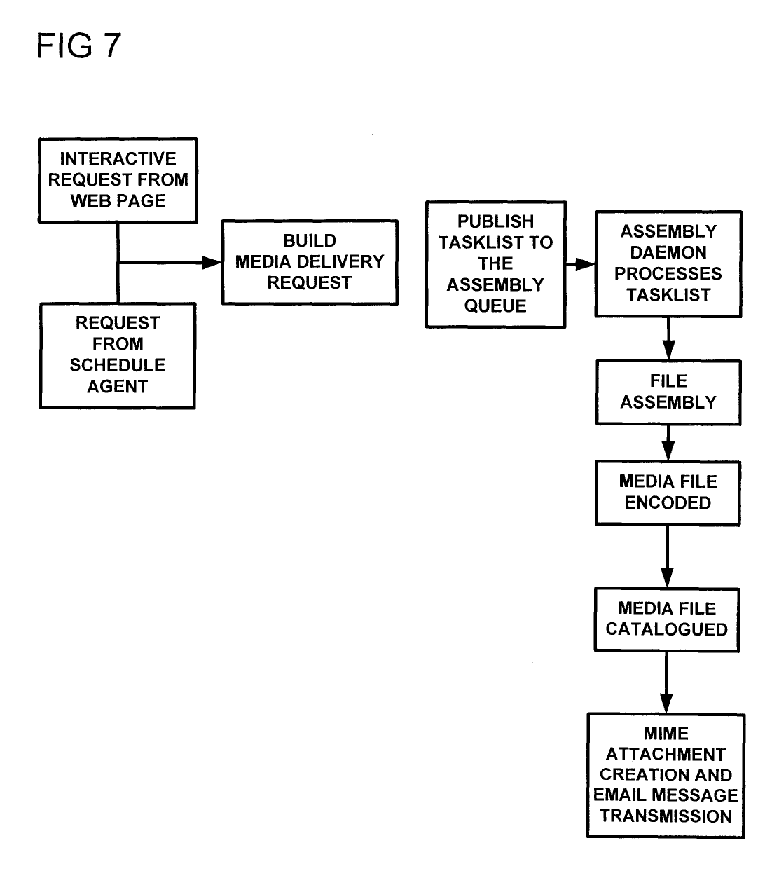

If a discrete product package does not already exist, the administrator may then create programs and packages using the Builder 50 application (see, FIG. 1). This figure illustrates the relationships between these various components. Using the Builder 50 the administrator visually defines a “recipe” (or instruction set) for an individual program using a set of commands. In the preferred implementation, these commands are used to assemble an audio file comprised of a set of digitized audio segments stored in a location accessible to the AAD 40 (see, also FIG. 7).

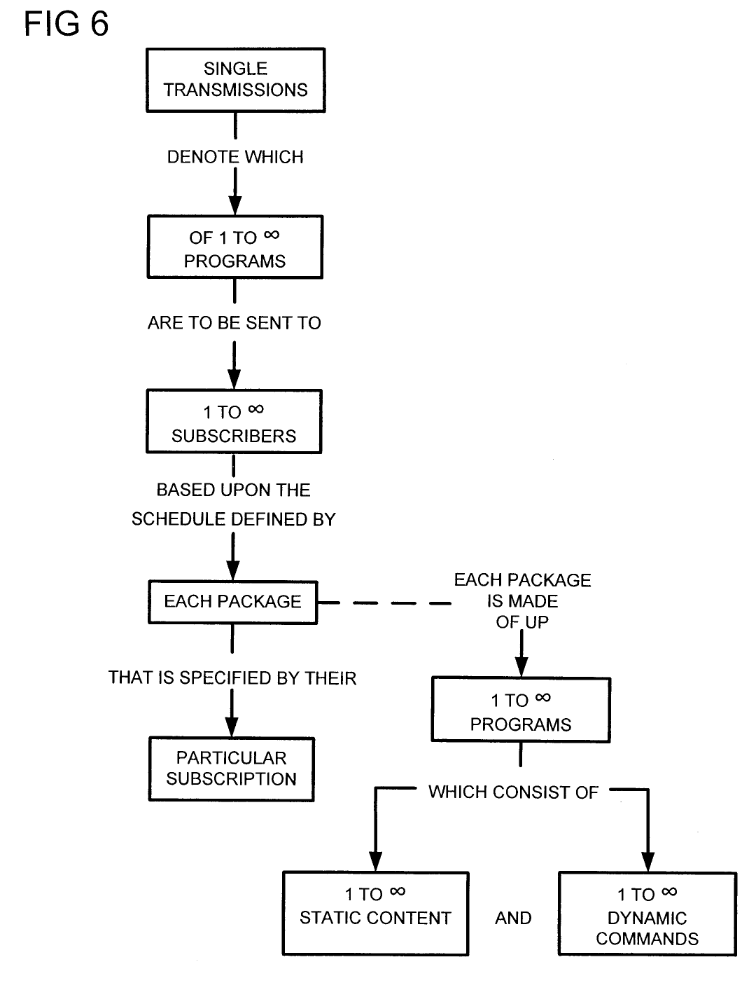

Referring now to FIG. 6, an alternative embodiment of a second logical model illustrating the nature of individual transmissions and packages respectively is shown. Transmissions to subscribers, as noted above, consist of programs that are sent on a regular and scheduled basis. The subscription itself is derived from an individual package itself made up of programs derived from a collection of static program content combined with a set of dynamic commands that provide the “recipe” used to assemble the collection of static and dynamic content into a complete program. In the preferred implementation, this recipe provides intelligence to the system allowing it to custom tailor the finished content provided to a specific subscriber based upon either a pre-defined script or system-driven decisions derived from data collected about or from a subscriber.

Referring to FIG. 7, a set of commands are used to load a given static media file and a given dynamic media file, and append additional segments to that file to create an overall program. Once completed, a command is given to save the file and encode it according to a pre-determined compression scheme. After this process is completed, another command orders the cataloging and transmission of the file respectively. The AAD 40 is designed to use an outbound processor for the transmission of content files. In the preferred implementation the AAD 40 assembles audio files and encodes them into a single, subscriber personalized MP3 file. This audio content is then personalized for the subscriber and, as noted, may further include other dynamic elements (such as personal objectives, company information, boss's name, location, current events, date of the message, news event flashes related to the subscriber, and references to prior communications and survey results) specific to a given subscriber. After dynamically creating the MP3 file, the file is attached to an e-mail message and transmitted using the standard Simple Mail Transmission Protocol (SMTP) directly to the subscriber together with custom e-mail message text.

After receiving a media file, the subscriber is free to view the file independently using an array of readily available consumer hardware such as a desktop computer, a laptop computer, a portable MP3 player, and/or handheld PDA devices. It is important to note that a subscriber's use of the file is not tied to the maintenance of an active connection as is required by electronic streaming media formats. And, the presence of personalized information and of identifying information about the subscriber embedded directly in the media file itself discourages redistribution.

In the preferred implementation, a series of audio training sessions are transmitted to individual subscribers on a daily, weekly or monthly basis. In the case of daily transmissions, for example, each program would include the day's lesson together with dynamic information about the subscriber and a related set of information about their company or industry news. News items would remain current and would be updated daily as content is dynamically assembled “just in time” prior to transmission. Transmission failures are automatically handled, while users have the ability to request, either online or by manually contacting an administrator, an adjustment to the transmission schedule or retransmission.

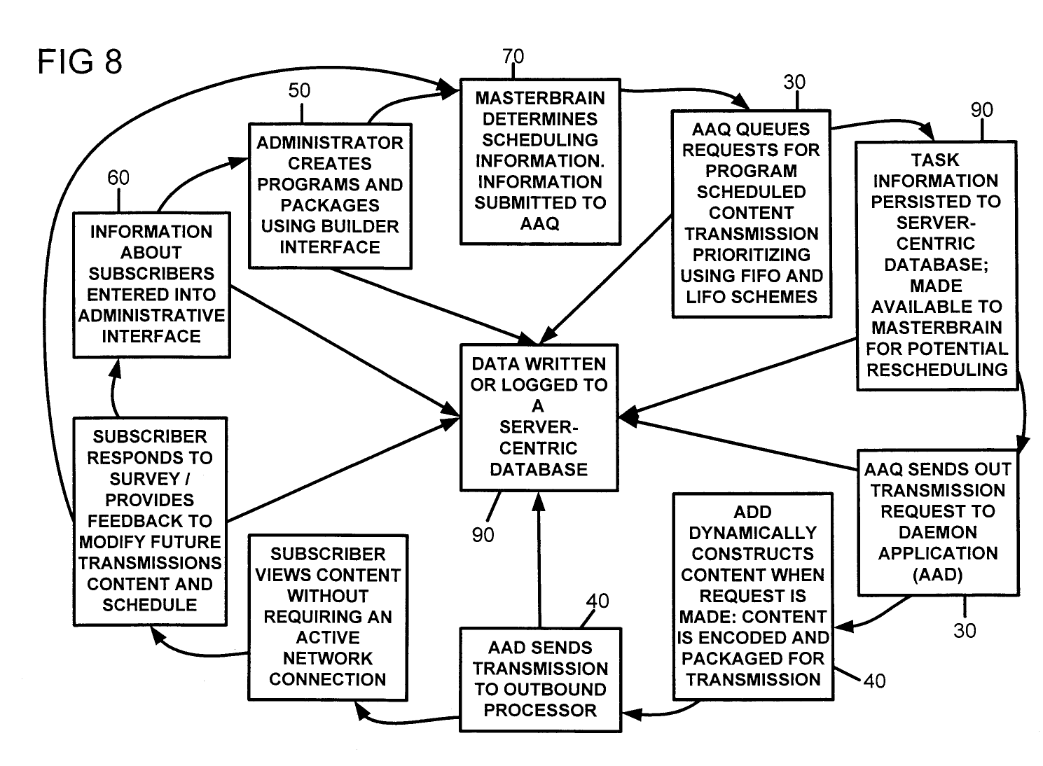

Referring now to FIG. 8, a preferred implementation is depicted, with a human administrator, or subscriber with a web interface who begins by using the Administrator Interface 60 to enter information about subscribers, including name, destination addresses and associated corporate information. The Administrator Interface 60 may consist of an individual administrator or an interface to be created by individual subscribers, or remote administrators. As data is recorded additional demographic information about a particular subscriber may also be noted. Assuming programming has already been created, the user would then use the Administrator interface 60 to add or maintain subscriptions to various content packages and programs, and to schedule the transmission of that content. Using this interface 60, content transmission can be scheduled to occur at regular intervals, a key feature of the system. In addition, content transmission can be later rescheduled if a particular subscriber is unavailable to receive, or content may be scheduled to retransmit if a transmission failure has occurred. Planned delays in a delivery schedule may be used to update the schedule such as postponing weekly delivery of content while an individual is on vacation or out of the country. The interface component may also be used to monitor pending transactions, and provides up-to-date information on their status.

Note that various predefined points in the process flow when the system updates data within the central database with subscriber, logging, and/or feedback information. In the preferred implementation this database is driven by structured query language and may be one of a variety of products accessible through a database control standard such as the Open Database Connectivity (ODBC) standard including those available from Oracle and Microsoft, for example. The database acts as the key repository for information related to the assembly of data and its transmission, and the relationship between media products and subscribers. The database may be further leveraged to provide sample media products for marketing purposes using the same distribution methods described herein. Finally, the database stores information derived from feedback surveys regarding the individual subscriber's effectiveness, the needs of the subscriber, the preferences of the subscriber, and relevancy of provided content.

A feature of the system as illustrated in the figure is that the completed transmission of a given program leads to a survey of the subscriber that allows the system to derive information about the effectiveness and appropriateness of both the content and the transmission schedule.

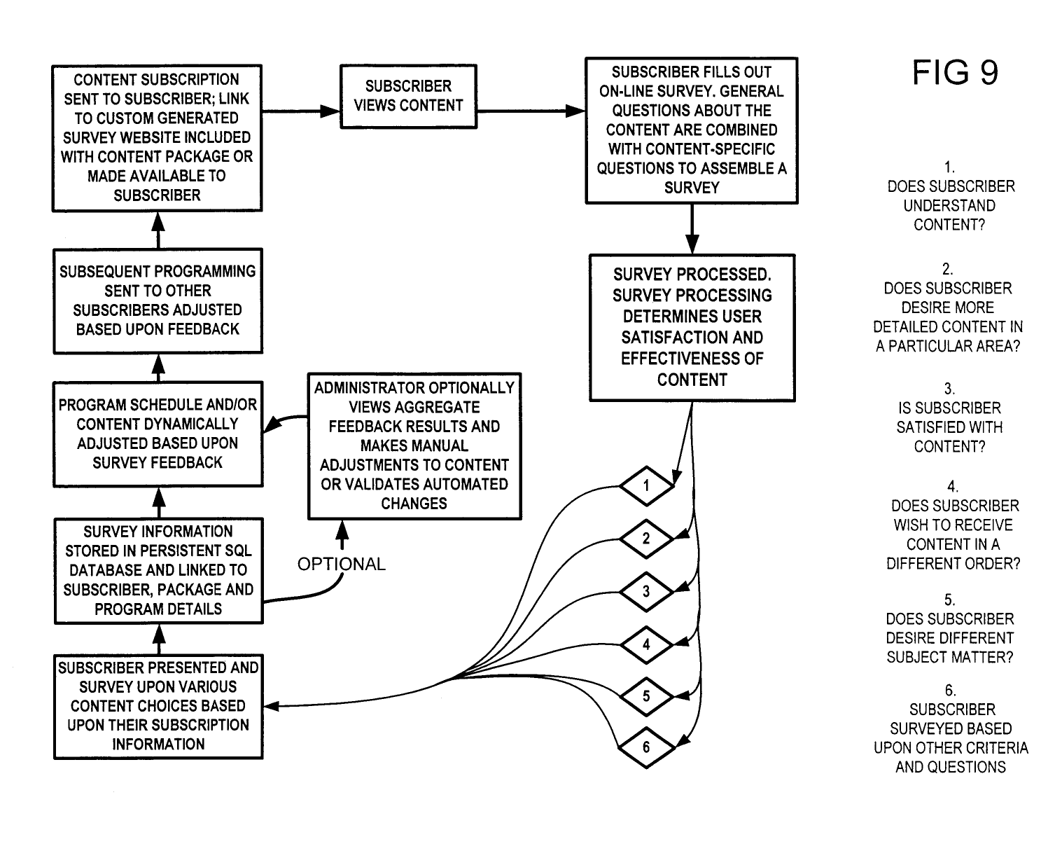

Referring now to FIG. 9, a preferred embodiment of the surveying process is depicted. Here, a user is provided with the Internet web address of a survey in the e-mail to which content is attached for transmission. After viewing the media program, the user completes the survey on-line providing feedback about the content itself, the order in which it was received and its overall utility. After completing this survey the user may then be asked for feedback on a future transmission schedule or on alternative content choices for subsequent transmissions. This information is then used by the system to derive future programming and scheduling for both the individual subscribers and other subscribers to the same programming package.

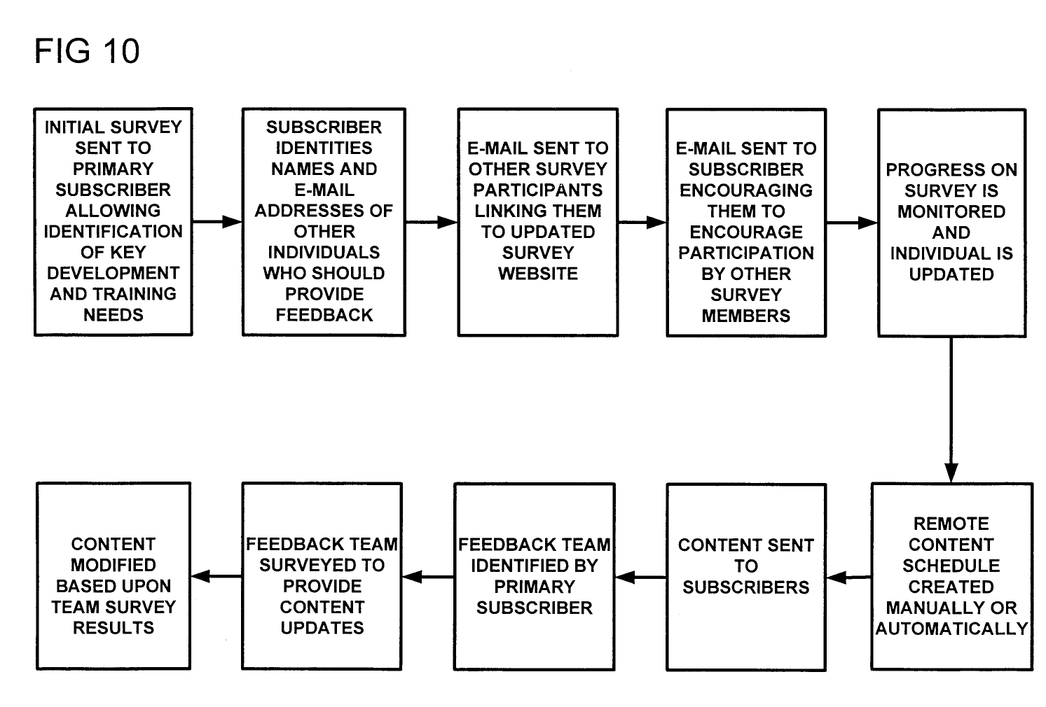

Referring now to FIG. 10, an alternative embodiment of the system is illustrated. The system, as depicted, may be used in conjunction with a set of initial surveys to identify the actual content contained in the package that is sent to subscribers (see, for example, FIG. 9). In this embodiment, a primary subscriber is identified at the outset of a project. This primary subscriber identifies, through on-line surveys, areas they would like to receive information (for example, professional development needs or personal goals). The primary subscriber then enters a list of names and e-mail address of individuals from whom the primary subscriber would like to receive subsequent survey results. E-mails are then sent to survey participants linking them to a survey website. The survey participants are asked a series of questions regarding the primary subscriber's effectiveness. This website is monitored, either automatically by the system or manually, and the primary subscriber is notified of survey progress while the system suggests that he or she encourage survey participants to fill out their survey form(s). When completed, the system uses the survey results to create a complete content schedule for the recipient. The dynamic content scheduled for the primary subscriber is created based on the survey results from the survey participants. After regular program deliveries begin, a “feedback team” of subscribers (that are able to observe the primary subscriber, and who also may be survey participants) is identified by the primary subscriber to be regularly surveyed. These “feedback team” surveys are used to monitor progress and as a result, modify content being sent to the primary subscriber on an ongoing basis. Ultimately, the surveys are coupled with the results of content-recipient surveys as illustrated in FIG. 9.

The embodiments described herein, including the Assembly Queue, Assembly Daemon, Administrator Interface, Server-Centric (or Persistent) Database, Masterbrain and Master Control Program and on-line survey information are implemented as software applications residing on a network of computers with appropriate additional software and related hardware. These particular components are preferably implemented in software, although specific tasks may be supplemented with hardware devices. To provide for scalability one or more of these systems may be deployed. The persistent database is provided on a system of similar specifications and is preferably ODBC compliant. In the preferred embodiment systems communicate using the TCP/IP protocol over Internet, Extranet, Ethernet or a compatible network transport. Adherence to these open standards insures support for emerging wireless transmission technologies as they arrive, and the system is able to support networking and transmission protocols independent of the chosen network topology.

While there has been illustrated and described what are at present considered to be preferred embodiments and methods of the present invention, it will be understood by those skilled in the art that various changes and modifications may be made, and equivalents may be substituted for elements thereof without departing from the true scope of the invention.

In addition, many modifications may be made to adapt a particular element, technique or implementation to the teachings of the present invention without departing from the central scope of the invention. Therefore, it is intended that this invention not be limited to the particular embodiments and methods disclosed herein, but that the invention include all embodiments falling within the scope of the appended claims.

We claim:

1. A distribution system for delivering dynamically assembled media, the distribution system comprising:
a plurality of custom content media programs arranged into discrete, subscriber selectable products;
an assembler for bundling a predetermined number of subscriber selected discrete products to create individualized subscriber specific packages; and,
a processor for transmitting the subscriber specific packages in a predetermined order to a subscriber.

2. The distribution system of claim 1, further comprising:
a builder for designing the custom content media programs.

3. The distribution system of claim 1, wherein a portion of the custom content media programs comprise dynamic content.

4. The distribution system of claim 1, wherein a portion of the custom content media programs is generated dynamically, just prior to transmission.

5. The distribution system of claim 1, wherein the custom content media programs are encoded and compressed prior to transmission.

6. The distribution system of claim 1, wherein the system is able to collect and distribute a predetermined number of subscriber specific package transmissions across multiple networked hardware devices.

7. The distribution system of claim 1, wherein the system has the ability to analyze feedback and retransmit subscriber specific packages that fail to be transmitted successfully.

8. The distribution system of claim 1, wherein a portion of the custom content media programs is interactive.

9. The distribution system of claim 1, wherein a portion of the custom content media programs is based upon predetermined demographic criteria.

10. The distribution system of claim 1, wherein the custom content media programs may be modified based upon feedback from a subscriber.

11. The distribution system of claim 1, wherein a portion of the custom content media programs includes embedded information designed to deter file sharing.

12. The distribution system of claim 1, wherein a portion of the custom content media programs comprises third party information, and wherein the third party information is used to modify the program to meet a subscriber's changing needs.

13. A method of delivering dynamically assembled, personalized media to a plurality of subscribers, the method comprising the steps of:
a. creating a plurality of custom content media programs arranged into discrete, subscriber selectable products;
b. assembling subscriber selected discrete products to create individualized subscriber specific packages; and,
c. transmitting the packages in a predetermined order to at least one subscriber.

14. The method of claim 13, wherein a portion of the custom content media programs comprises dynamic content.

15. The method of claim 13, wherein a portion of the custom content media programs is generated dynamically, just prior to transmission.

16. The method of claim 13, wherein a portion of the custom content media program is encoded prior to transmission.

17. The method of claim 13, wherein a portion of the custom content media program is interactive.

18. The method of claim 13, wherein a portion of the custom content media programs comprises embedded information designed to deter file sharing.

19. The method of claim 13, wherein the step of creating custom content media programs comprises the step of selecting content that is specific to a subscriber.

20. A method of customizing delivery of dynamically assembled, personalized media to a subscriber, the method comprising the steps of:
a. creating a plurality of custom content media programs arranged into discrete subscriber selectable products;
b. assembling subscriber selected discrete products to create a personalized subscriber specific package;
c. transmitting the package to a subscriber; and
d. modifying subsequent transmittals.

21. The method of claim 20, wherein the step of modifying subsequent transmittals is based upon subscriber related responses generated by the subscriber.

22. The method of claim 20, wherein the step of modifying subsequent transmittals is based upon subscriber related responses generated by a third party.

23. The method of claim 20, wherein the step of modifying subsequent transmittals is generated at predetermined intervals.

24. The method of claim 20, wherein the step of modifying subsequent transmittals is based upon archived, personal data.

25. The method of claim 20, wherein the step of assembling the products into a subscriber specific package includes the generation of customized content just prior to the step of transmission.

26. The distribution system of claim 6 wherein the multiple networked hardware devices are from the group comprising: a computer, a portable MP3 player, a mobile telephone, and a personal data assistant (PDA).

27. A distribution system for delivering dynamically assembled media, the distribution system comprising:
a plurality of custom content media programs, with each program arranged into a plurality of discrete subscriber selectable products;
an assembler for bundling a predetermined number of subscriber selected discrete products to create subscriber specific packages; and,
a processor for transmitting the subscriber specific packages in a predetermined order to a subscriber.
